(19) United States
(12) Patent Application Publication
(10) Pub. No.: US 2019/0236694 A1
(43) Pub. Date: Aug. 1, 2019

(54) PREDICTIVE RISK MANAGEMENT FOR SUPPLY CHAIN RECEIVABLES FINANCING

(71) Applicant: Electronic German Link GmbH, Bad Oldesloe (DE)

(72) Inventor: Britta Balden, Bad Oldesloe (DE)

(21) Appl. No.: 15/886,693

(22) Filed: Feb. 1, 2018

(51) Int. Cl. G06Q 40/02; G06Q 30/04; G06Q 10/06; G06Q 10/08

(52) U.S. Cl. CPC G06Q 40/025; G06Q 10/0838; G06Q 10/06375; G06Q 30/04

(57) ABSTRACT

A method for the predictive risk management of supply chain receivables financing includes specifying an invoice for goods supplied in a supply chain and selected for asset backed financing and determining both a buyer and a supplier in the supply chain associated with the invoice. The method also includes retrieving a set of prior transactions in the supply chain involving products contracted for supply from the identified supplier and characterizing each of the transactions in the set as a perfect order or an imperfect order. Finally, the method includes computing a supply chain excellency score for the identified supplier based upon the imperfect orders as compared to the perfect orders in the set and displaying an alert on condition that the supply chain excellency score falls below a threshold value indicating a predicted risk of non-payment of the invoice selected for asset backed financing.

### BACKGROUND OF THE INVENTION

### Field of the Invention

The present invention relates to the field of supply chain receivables financing and more particularly to programmatic risk mitigation in supply chain receivables financing.

### Description of the Related Art

A supply chain is a network between a company and its suppliers to produce and distribute a specific product, and the supply chain represents the steps it takes to get the product or service to the customer. Supply chain management is a crucial process because an optimized supply chain results in lower costs and a faster production cycle. Business logistics management refers to the production and distribution process within the company, while supply chain management includes suppliers, manufacturers, logistics and transportation companies and retailers that distribute the product to the end customer. Supply chains include every business that comes in contact with a particular product, including companies that assemble and deliver parts to the manufacturer.

Factoring is a financial transaction and a type of debtor finance in which a business in the supply chain sells at a discount its accounts receivable of a buyer to a third party often referred to as a factor. A business in a supply chain often will “factor” receivable assets to meet present and immediate cash needs generally to support manufacturing and growth efforts. Factoring is commonly referred to as accounts receivable factoring, invoice factoring, and sometimes accounts receivable financing. But, accounts receivable financing is a term most accurately used to describe this form of asset based lending against accounts receivable.

In factoring, the initial sale of a receivable by a seller in the supply chain transfers ownership of the receivable to the factor, such that the factor obtains all of the rights associated with the receivables. Accordingly, the receivable becomes the asset of the factor, and the factor obtains the right to receive the payments made by the debtor for the invoice amount, and is free to pledge or exchange the receivable asset without unreasonable constraints or restrictions. Usually, the account debtor is notified of the sale of the receivable, and the factor makes all collections; however, non-notification factoring, where the seller collects the accounts sold to the factor, as agent of the factor, also occurs.

If the factoring transfers the receivable “without recourse”, the factor must bear the loss if the account debtor does not pay the invoice amount. If the factoring transfers the receivable “with recourse”, the factor has the right to collect the unpaid invoice amount from the seller. However, any merchandise returns that may diminish the invoice amount that is collectible from the accounts receivable are typically the responsibility of the seller, and the factor will typically hold back paying the seller for a portion of the receivable being sold, known as the “factor's holdback receivable” in order to cover the merchandise returns associated with the factored receivables until the privilege to return the merchandise expires. As can be seen, then, in factoring without recourse, the factor must reliable estimate the risk of non-payment of a factored invoice by a buyer to the seller of merchandise.

Factored invoices go unpaid for many reasons. The most common reason is the failure of the buyer to pay the factored invoice. The risk of non-payment, however, may be accounted for in connection with the acquisition of credit insurance. However, credit insurance does not account for the circumstance where the seller of goods to the buyer for which the buyer is invoiced cannot deliver goods of sufficient quality or when the seller cannot deliver goods of sufficient quality or when the seller cannot deliver the invoiced goods in a timely manner, these three factors defining a “perfect order”. In those instances, a dispute arises between buyer and seller leaving the factor in limbo and at risk of non-payment. Accordingly, mitigating the risk of non-payment of a factored invoice due to an “imperfect order” would be desirable.

### BRIEF SUMMARY OF THE INVENTION

Embodiments of the present invention address deficiencies of the art in respect to the mitigation of the risk of non-payment of a factored invoice and provide a novel and non-obvious method, system and computer program product for the predictive risk management of supply chain receivables financing. In an embodiment of the invention, a method for predictive risk management of supply chain receivables financing includes specifying in user interface of a host computer program executing in memory of a host computing system, an invoice for goods supplied in a supply chain and selected for asset backed financing and determining by the host computer program both a buyer and a supplier in the supply chain associated with the invoice. The method also includes retrieving from the memory a set of prior transactions in the supply chain involving products contracted for supply from the identified supplier and characterizing by the host computer program each of the transactions in the set as a perfect order or an imperfect order. Finally, the method includes computing by the host computer program a ratio of perfect to imperfect transactions in the set as a supply chain excellency score for the identified supplier and displaying in the user interface an alert on condition that the supply chain excellency score falls below a threshold value indicating a predicted risk of non-payment of the invoice selected for asset backed financing.

In one aspect of the embodiment, the method additionally includes filtering from the set, each of the transactions characterized as perfect and, for each remaining transaction in the set, determining a root cause in the supply chain of the imperfect characterization and whether or not the root cause has been remediated, and modifying the supply chain excellency score upwards on account of the root cause having been remediated, but modifying the supply chain excellency score downwards on account of the root cause not having been remediated. In this regard, the determination of the root cause can include the untimely delivery of corresponding goods, an improper quantity of goods delivered or a poor quality of goods delivered. As well, the supply chain excellency score can be modified downwards by a lesser amount when the goods associated with the root cause are supplied indirectly by the identified supplier to the buyer from an upstream supplier in the supply chain, but by a greater amount when the goods associated with the root cause are supplied directly to the buyer by the identified supplier.

In another aspect of the embodiment, the method additionally includes computing a composite excellency score for each corresponding one of the remaining ones of the transactions in the set by first computing for each of the remaining ones of the transactions a component excellency score for each supplier in the supply chain associated with a corresponding one of the remaining ones of the transactions in the set and second compositing the component excellency scores into the composite excellency score. Then, each composited excellency scores for each of the remaining ones of the transactions are combined into the supply chain excellency score. As well, when combining the composited excellency scores, the composited excellency scores for more recent ones of the remaining ones of the transactions are weighted more heavily than composited excellency scores for less recent ones of the remaining ones of the transactions.

In another embodiment of the invention, a supply chain invoice financing risk mitigation data processing system is configured for predictive risk management of supply chain receivables financing. The system includes a host computing system having one or more computers, each with memory and at least one processor. The system also includes a risk mitigation module executing in the memory of the host computing system. The module includes program code enabled during execution in the memory to specify in a user interface of the module, an invoice for goods supplied in a supply chain and selected for asset backed financing, to determine both a buyer and a supplier in the supply chain associated with the invoice, to retrieve from the memory a set of prior transactions in the supply chain involving products contracted for supply from the identified supplier, to characterize each of the transactions in the set as a perfect order or an imperfect order, to compute a ratio of perfect to imperfect transactions in the set as a supply chain excellency score for the identified supplier, and to display in the user interface an alert on condition that the supply chain excellency score falls below a threshold value indicating a predicted risk of non-payment of the invoice selected for asset backed financing.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for predictive risk management of supply chain receivables financing;

FIG. 2 is a schematic illustration of a data processing system adapted for predictive risk management of supply chain receivables financing;

FIG. 3 is a flow chart illustrating a process for predictive risk management of supply chain receivables financing; and,

FIG. 4 is a flow chart illustrating a process for excellency score computation in predictive risk management of supply chain receivables financing.

### DETAILED DESCRIPTION OF THE INVENTION

Embodiments of the invention provide for predictive risk management of supply chain receivables financing. In accordance with an embodiment of the invention, an invoice selected for factoring can be analyzed to identify a buyer and seller engaged in a transaction within a supply chain. A past set of transactions associated with the seller may then be analyzed to identify those of the transactions in the set that are characterized as perfect transactions without fault of improper quantity, quality or timing of delivery. As well, those of the transactions in the set characterized as imperfect also may be identified so that a supply chain excellency score may be assigned to the seller based upon the number of perfect transactions in the set, the number of imperfect transactions in the set and/or the nature of the imperfect transactions in the set. To the extent that the score falls below a threshold value, an alert is generated for the benefit of the factor indicating a higher than ordinary risk of financing the buyer on the strength of the invoice.

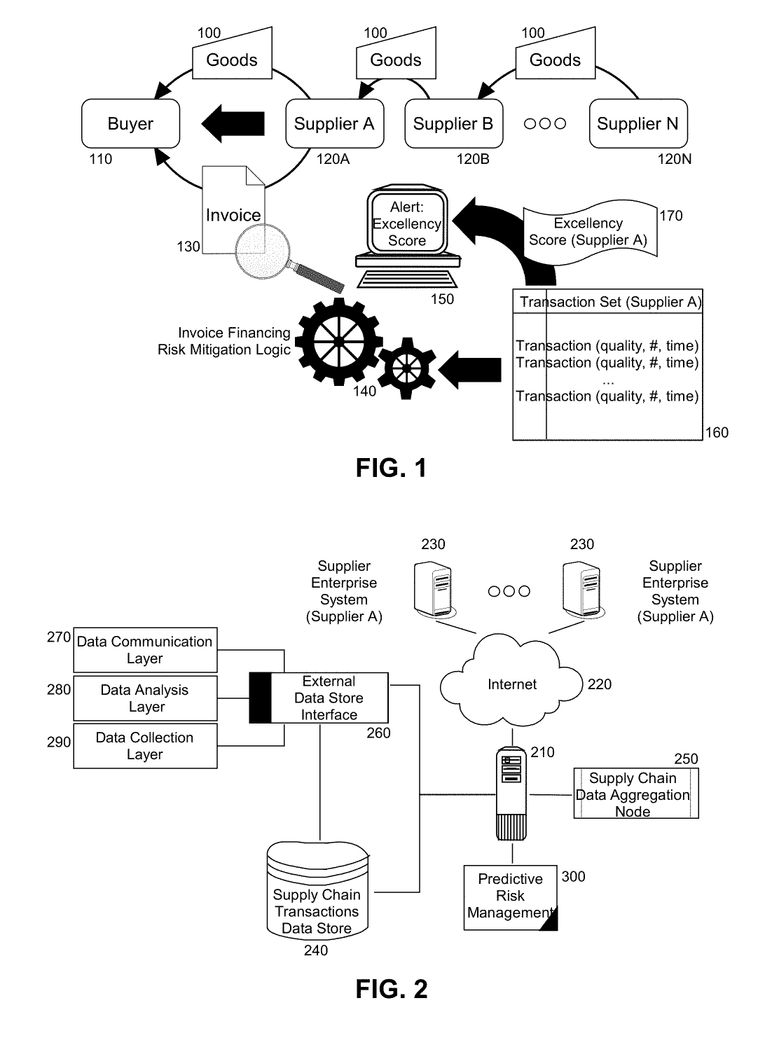

In further illustration, FIG. 1 is pictorial illustration of a process for predictive risk management of supply chain receivables financing. As shown in FIG. 1, a supply chain of a buyer 110 and one or more suppliers 120A supply goods 100 to the buyer 110. The supplier 120 directly supplying the goods 100 to the buyer 110, or indirectly supplying the goods 100 to the buyer 110 by way of one or more upstream suppliers 120B, 120N issues an invoice 130 to the buyer 110. Invoice financing risk mitigation logic 140 analyzes the invoice 130 to identify both the buyer 110 and the supplier 120A. Thereafter, invoice financing risk mitigation logic 140 computes an excellency score 170 for the supplier 120A based upon the number of perfect transactions present in transaction set 160 of past transactions with the supplier 120A. To the extent that the computed excellency score 170 falls below a threshold value, invoice financing risk mitigation logic 140 renders an alert in user interface 150 indicating a higher than ordinary risk in factoring the invoice 130.

In this regard, each of the transactions in the transaction set 160 may be characterized by invoice financing risk mitigation logic 140 as either perfect or imperfect. That is to say, a perfect transaction in the transaction set 160 is a transaction in which a promised good is delivered by a supplier 120A, 120B, 120N to a buyer 110 in the correct quantity ordered, of the correct quality ordered and within a time frame specified by the order. Conversely, an imperfect transaction is a transaction in which a promised good is delivered by the supplier 120A, 120B, 120N in the supply chain to a buyer 110 in any, some or all of an incorrect quantity, poorer than acceptable quality or outside the promised time frame of delivery. As will be recognized, a root cause of the imperfect order may be internal to a particular one of the suppliers 120A, 120B, 120N, or external to the particular one of the suppliers 120A, 120B, 120N in consequence of a failure of an upstream one of the suppliers 120B, 120N.

Whereas the invoice financing risk mitigation logic 140 assigns a maximum value to the excellency score 170 for the supplier 120A when all transactions in the transaction set 160 are characterized as perfect, the invoice financing risk mitigation logic 140 assigns less than the maximum possible value to the excellency score 170 when one or more of the transactions in the transaction set 160 are characterized as imperfect. In this regard, the reduction in value to the excellency score 170 may be dependent upon a number of the transactions in the transaction set 160 characterized as perfect in comparison to the number of the transactions in the transaction set 160 that are characterized as imperfect.

However, invoice financing risk mitigation logic 140 may assign different values to the excellency score 170 depending upon the root cause of each transaction characterized as imperfect and whether or not the root cause has been remediated so as to render the likelihood of recurrence of the root cause low. As well, the invoice financing risk mitigation logic 140 may assign different values to the excellency score 170 depending upon whether or not the root cause is the result of a failure internal to the supplier 120A, or the result of a failure in an upstream one of the suppliers 120B, 120N. Even further, the invoice financing risk mitigation logic 140 may reduce the excellency score 170 by a lesser amount when the mode in which the data collected by the supplier 120A is collected on an automated basis by a corresponding data processing system, but by a greater amount when the mode in which the data collected by the supplier 120A is collected through manual data entry. Likewise, the invoice financing risk mitigation logic 140 may reduce the excellency score 170 by a lesser amount when the mode in which the data collected by the supplier 120A is transmitted for analysis by the invoice financing risk mitigation logic 140 utilizing automated, secure means including encryption, direct application programming interface (API) connectivity or message routing through a message broker, but by a greater amount when the mode in which the data transmitted by the supplier 120A is manual such as by manually scanning a document, or through manual data entry.

Finally, the invoice financing risk mitigation logic 140 may compute a score for each of the transactions in the transaction set 160 and combine the computed scores into the excellency score 170 with the scores for more recent transactions in the transaction set 160 being weighted as more important during combination than less recent transactions in the transaction set 160. As well, each of the computed scores for a transaction in the transaction set 160 may be a composition of different composite scores for each of the suppliers 120A, 120B, 120N in a supply chain supplying a corresponding one of the goods 100 to the buyer 110 in a corresponding one of the transactions beginning with an originating one of the suppliers 120N and culminating with the supplier 120A providing the corresponding one of the goods to the buyer 110.

The process described in connection with FIG. 1 may be implemented in a data processing system of one or more computers, each with memory and at least one processor. In yet further illustration, FIG. 2 schematically shows a data processing system adapted for predictive risk management of supply chain receivables financing. The system includes a host computing system 210 of one or more computers, each with memory and at least one processor communicatively coupled over computer communications network 220 to different enterprise computing systems 230 of respectively different suppliers in a supply chain. A supply chain data aggregation node 250 executes in the memory of the host computing system 210 and aggregates in a supply chain transactions data store 240 transaction data recorded as between different suppliers engaging in different transactions supply goods to other suppliers and ultimately a corresponding buyer, as evidenced from data records in the supplier enterprise systems 230.

In this regard, an external data source interface 260 is provided through which the different enterprise computing systems 230 report the transaction data to the supply chain transactions data store 240. To that end, the external data source interface 260 provides a data communications layer 270 that programmatically supports direct API access to the supply chain transactions data store 240 by exposing different programmatic operations accepting data for uploading to the supply chain transactions data store 240. As well, the provides a data communications layer 270 supports message based communications in which selected ones of the different enterprise computing systems 230 transmit messages encapsulating the data for uploading to the supply chain transactions data store 240. Finally, the data communications layer 270 supports manually submission of the data for uploading to the supply chain transactions data store 240 by publishing a user interface over the computer communications network permitting direct manual data entry of the data to be uploaded to the supply chain transactions data store 240, or by permitting uploading of a document able to be directly parsed in order to extract the data to be uploaded to the supply chain transactions data store 240, or able to be transformed into a parseable document by way of optical character recognition and then parsed in order to extract the data to be uploaded to the supply chain transactions data store 240.

In each case, a data collection layer 280 of the external data source interface 260 processes the uploaded data to ensure completeness based upon a pre-stored schema, a degree of integrity and authenticity of the uploaded data based upon one or more rules pertaining to the manner in which the uploaded data had been collected in the different enterprise computing systems 230 and the manner in which the data had been communicated to the external data source interface. More particularly, the data collection layer 280 stores with the uploaded data an indication not only of the mode in which the data is communicated to the external data store interface 260, but also the mode in which the data had been collected in each of the different enterprise computing systems 230 as reported by the different enterprise computing systems 230 to the external data store interface 260. Finally, a data analysis layer 290 of the external data store interface 260 ensures data consistency across other transactions in the supply chain by ensuring the uploaded data from one of the different enterprise computing systems 230 maps to uploaded data from another of the different enterprise computing systems 230 when a transaction involves the movement of product across suppliers in the supply chain corresponding to both of the different enterprise computing systems 230

Of note, a predictive risk management module 300 also executes in the memory of the host computing system 210. The predictive risk management module 300 includes program code that when executed in the host computing system 210, is enabled to identify an invoice of a supplier selected for asset backed financing. The program code additionally is enabled to identify a set of past transactions in the supply chain transactions store 240 for the supplier and to characterize ones of the past transactions as either perfect or imperfect, the perfect transactions involving a delivery of goods to a buyer in the the ordered quantity, of the ordered quality and within the ordered time frame. The program code yet further is enabled to compute an excellency score for the supplier based upon a number of transactions characterized as perfect relative to the total number of the past transactions. The program code even yet further is enabled to modify the excellency score so as to produce a better excellency score based upon data uploaded to the supply chain transactions store 240 having been uploaded utilizing automated methods as opposed to manual methods, and also based upon data identified as having been collected in the different enterprise computing systems 230 in an automated fashion as opposed to the use of manual data entry. Finally, the program code is enabled to display an alert to an operator when the computed excellency score falls below a threshold value.

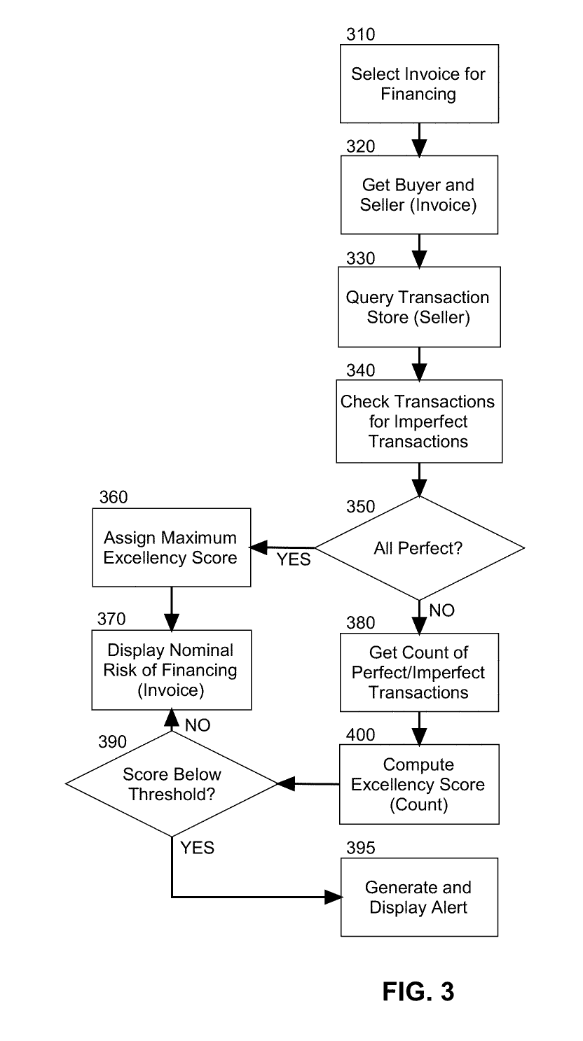

In even yet further illustration of the operation of the predictive risk management module 300, FIG. 3 is a flow chart illustrating a process for predictive risk management of supply chain receivables financing. Beginning in block 310, an invoice selected in a user interface of a computer program managing supply chain financing. In block 320, a buyer and seller are identified in the computer program from the invoice. In block 330, a transaction store is queried to locate past transactions in which the identified supplier provided goods to a requesting buyer. Thereafter, in decision block 340, it is determined whether or not imperfect transactions are present in the past transactions. In decision block 350, if all of the past transactions are determined to have been perfect, in block 360 a maximum value is assigned to an excellency score for the supplier and in block 370, the computer program renders a display of nominal risk in factoring the invoice. But, in the event that in decision block 350 it is determined that not all of the past transactions were perfect, the process continues through block 380.

In block 380, a count of the perfect and imperfect transactions amongst the past transactions for the supplier is determined. Then, in block 400, an excellency score is computed in respect to the count. In decision block 390, to the extent that the computed excellency score falls below a threshold value, in block 395 an alert is generated in the user interface indicating an above normal risk in factoring the invoice. Otherwise, in block 370 the computer program renders a display of nominal risk in factoring the invoice.

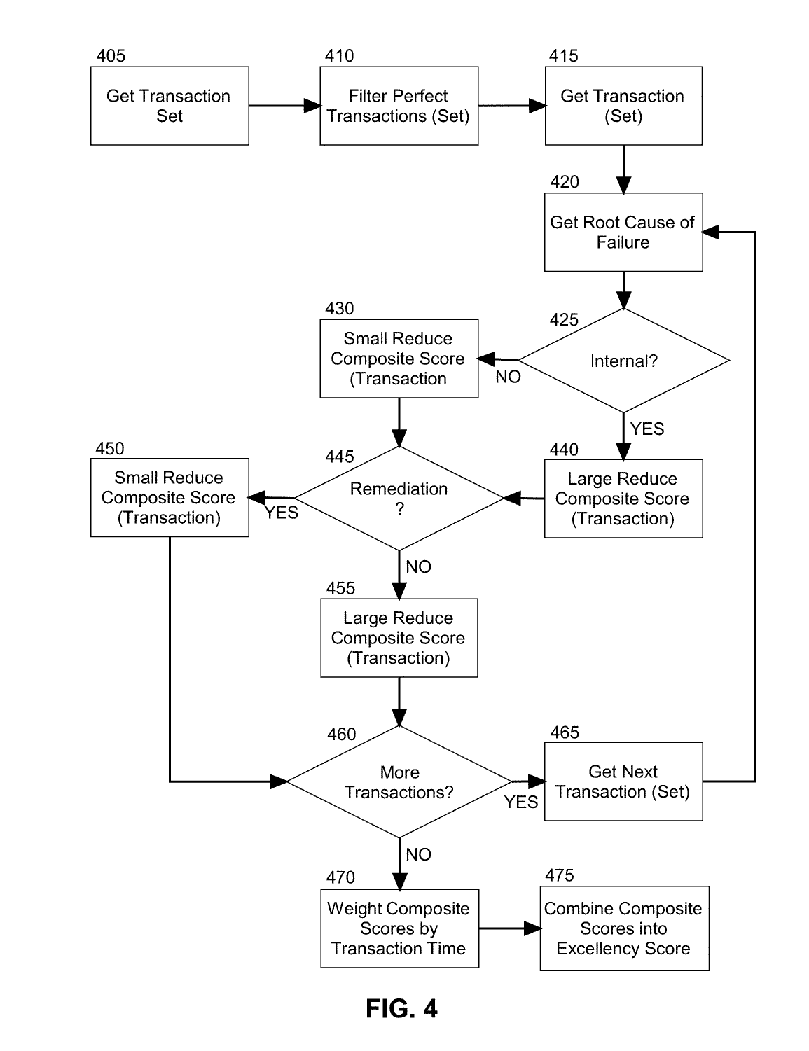

In even yet further illustration of the process of computing the excellency score for the supplier based upon the presence of one or more imperfect transactions, FIG. 4 is a flow chart illustrating a process for excellency score computation in predictive risk management of supply chain receivables financing. Beginning in block 405, a transaction set of past transactions for the selected supplier is retrieved from a data store and in block 410, the transaction set is filtered to exclude therefrom, transactions characterized as perfect leaving in the transaction set only transactions characterized as imperfect. Then, in block 415, a first transaction in the filtered set is selected for processing and in block 420, a root cause of failure for the selected transaction is identified, for instance, a deficiency in delivered quantity of goods, a deficiency in delivered quality of goods, or a deficiency in delivering the goods within a pre-specified time frame.

In decision block 425, it is determined if the root cause is internal to the supplier, or external to the supplier in consequence of a failure by an upstream supplier to deliver the goods to the selected supplier. If not, in block 430 a composite score for the transaction is reduced by a small amount, but if so, in block 440 the composite score for the transaction is reduced by a larger amount. As well, in decision block 445 it is determined whether or not the root cause has since been remediated so as to reduce the likelihood of the failure to occur again. For instance, to the extent that the root cause is associated with the upstream supplier in the supply chain such as a third party logistics entity, if it is reported that the upstream supplier has been removed from the supply chain by the selected supplier, the root cause is considered remediated. In this regard, to the extent that each supplier in a supply chain indicated for a particular transaction provides data associated with a corresponding identifier, for each transaction, the involved suppliers may be automatically identified such that the presence or absence of an identifier for a particular supplier indicates which suppliers are upstream to other ones of the suppliers. As such, the presence of an upstream supplier identified as a root cause of an imperfect transaction for one transaction, but the absence of the same upstream supplier in a subsequent transaction for the same selected supplier indicates the removal of the upstream supplier from the supply chain.

In any event, if in decision block 445 it is determined that the root cause has since been remediated so as to reduce the likelihood of the failure to occur again, in block 450 only a small reduction in the composite score is applied. Otherwise, in block 445 a larger reduction in the composite score is applied. Thereafter, in decision block 460 it is determined if additional transactions in the set remain to be processed. If so, in block 465 a next transaction in the set is selected for processing in order to compute a composite score for the next transaction. Otherwise, in block 470 the composite scores computed for each of the transactions in the set are each weighted based upon a recency of the transactions with the most recent transactions receiving the highest weighting and the least recent transactions receiving the lowest weighting. Finally, in block 475 the weighted composite scores are combined to form the excellency score of the selected supplier.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A method for predictive risk management of supply chain receivables financing, the method comprising:
specifying in user interface of a host computer program executing in memory of a host computing system, an invoice for goods supplied in a supply chain and selected for asset backed financing;
determining by the host computer program both a buyer and a supplier in the supply chain associated with the invoice;
retrieving from the memory a set of prior transactions in the supply chain involving products contracted for supply from the identified supplier;
characterizing by the host computer program each of the transactions in the set as a perfect order or an imperfect order;
computing by the host computer program a supply chain excellency score for the identified supplier based upon the imperfect orders as compared to the perfect orders in the set; and,
displaying in the user interface an alert on condition that the supply chain excellency score falls below a threshold value indicating a predicted risk of non-payment of the invoice selected for asset backed financing.

2. The method of claim 1, further comprising:
filtering from the set, each of the transactions characterized as perfect; and,
for each remaining transaction in the set, determining a root cause in the supply chain of the imperfect characterization and whether or not the root cause has been remediated, and modifying the supply chain excellency score upwards on account of the root cause having been remediated, but modifying the supply chain excellency score downwards on account of the root cause not having been remediated.

3. The method of claim 2, wherein the determination of the root cause includes at least one root cause selected from the group consisting of delayed delivery of corresponding goods, an improper quantity of goods delivered and a poor quality of goods delivered.

4. The method of claim 2, wherein the supply chain excellency score is modified downwards by a lesser amount when the goods associated with the root cause are supplied indirectly by the identified supplier to the buyer from an upstream supplier in the supply chain, but by a greater amount when the goods associated with the root cause are supplied directly to the buyer by the identified supplier.

5. The method of claim 2, wherein the supply chain excellency score is modified downwards by a lesser amount when data supplied by the identified supplier indicating the root cause is automatically captured by a data processing system at the identified supplier and transmitted to the memory utilizing automated integrated communications, but by a greater amount when the data supplied by the identified supplier indicating the root cause is manually entered by an operator of the data processing system.

6. The method of claim 2, further comprising:
computing a composite excellency score for each corresponding one of the remaining ones of the transactions in the set by:
first computing for each of the remaining ones of the transactions a component excellency score for each supplier in the supply chain associated with a corresponding one of the remaining ones of the transactions in the set and
second compositing the component excellency scores into the composite excellency score; and,
combining each composited excellency scores for each of the remaining ones of the transactions into the supply chain excellency score.

7. The method of claim 6, wherein when combining the composited excellency scores the composited excellency scores for more recent ones of the remaining ones of the transactions are weighted more heavily than composited excellency scores for less recent ones of the remaining ones of the transactions.

8. A supply chain invoice financing risk mitigation data processing system configured for predictive risk management of supply chain receivables financing, the system comprising:
a host computing system comprising one or more computers, each with memory and at least one processor; and,
a risk mitigation module executing in the memory of the host computing system, the module comprising program code enabled during execution in the memory to specify in a user interface of the module, an invoice for goods supplied in a supply chain and selected for asset backed financing, to determine both a buyer and a supplier in the supply chain associated with the invoice, to retrieve from the memory a set of prior transactions in the supply chain involving products contracted for supply from the identified supplier, to characterize each of the transactions in the set as a perfect order or an imperfect order, to compute an excellency score for the identified supplier based upon the imperfect orders as compared to the perfect orders in the set, and to display in the user interface an alert on condition that the supply chain excellency score falls below a threshold value indicating a predicted risk of non-payment of the invoice selected for asset backed financing.

9. The system of claim 8, wherein the program code is further enabled to filter from the set, each of the transactions characterized as perfect, and, for each remaining transaction in the set, to determine a root cause in the supply chain of the imperfect characterization and whether or not the root cause has been remediated, and to modify the supply chain excellency score upwards on account of the root cause having been remediated, but to modify the supply chain excellency score downwards on account of the root cause not having been remediated.

10. The system of claim 9, wherein the determination of the root cause includes at least one root cause selected from the group consisting of delayed delivery of corresponding goods, an improper quantity of goods delivered and a poor quality of goods delivered.

11. The system of claim 9, wherein the supply chain excellency score is modified downwards by a lesser amount when the goods associated with the root cause are supplied indirectly by the identified supplier to the buyer from an upstream supplier in the supply chain, but by a greater amount when the goods associated with the root cause are supplied directly to the buyer by the identified supplier.

12. The system of claim 9, wherein the supply chain excellency score is modified downwards by a lesser amount when data supplied by the identified supplier indicating the root cause is automatically captured by a data processing system at the identified supplier and transmitted to the memory utilizing automated integrated communications, but by a greater amount when the data supplied by the identified supplier indicating the root cause is manually entered by an operator of the data processing system.

13. The system of claim 9, wherein the program code is further enabled to compute a composite excellency score for each corresponding one of the remaining ones of the transactions in the set by:
first computing for each of the remaining ones of the transactions a component excellency score for each supplier in the supply chain associated with a corresponding one of the remaining ones of the transactions in the set and
second compositing the component excellency scores into the composite excellency score; and,
combining each composited excellency scores for each of the remaining ones of the transactions into the supply chain excellency score.

14. The system of claim 13, wherein when combining the composited excellency scores the composited excellency scores for more recent ones of the remaining ones of the transactions are weighted more heavily than composited excellency scores for less recent ones of the remaining ones of the transactions.

15. A computer program product for predictive risk management of supply chain receivables financing, the computer program product including a computer readable storage medium having program instructions embodied therewith, the program instructions executable by a device to cause the device to perform a method including:
specifying in user interface of a host computer program executing in memory of a host computing system, an invoice for goods supplied in a supply chain and selected for asset backed financing;
determining by the host computer program both a buyer and a supplier in the supply chain associated with the invoice;
retrieving from the memory a set of prior transactions in the supply chain involving products contracted for supply from the identified supplier;
characterizing by the host computer program each of the transactions in the set as a perfect order or an imperfect order;
computing by the host computer program a supply chain excellency score for the identified supplier based upon the imperfect orders as compared to the perfect orders in the set; and,
displaying in the user interface an alert on condition that the supply chain excellency score falls below a threshold value indicating a predicted risk of non-payment of the invoice selected for asset backed financing.

16. The computer program product of claim 15, wherein the method further comprises:
filtering from the set, each of the transactions characterized as perfect; and,
for each remaining transaction in the set, determining a root cause in the supply chain of the imperfect characterization and whether or not the root cause has been remediated, and modifying the supply chain excellency score upwards on account of the root cause having been remediated, but modifying the supply chain excellency score downwards on account of the root cause not having been remediated.

17. The computer program product of claim 16, wherein the determination of the root cause includes at least one root cause selected from the group consisting of delayed delivery of corresponding goods, an improper quantity of goods delivered and a poor quality of goods delivered.

18. The computer program product of claim 16, wherein the supply chain excellency score is modified downwards by a lesser amount when the goods associated with the root cause are supplied indirectly by the identified supplier to the buyer from an upstream supplier in the supply chain, but by a greater amount when the goods associated with the root cause are supplied directly to the buyer by the identified supplier.

19. The computer program product of claim 15, wherein the supply chain excellency score is modified downwards by a lesser amount when data supplied by the identified supplier indicating the root cause is automatically captured by a data processing system at the identified supplier and transmitted to the memory utilizing automated integrated communications, but by a greater amount when the data supplied by the identified supplier indicating the root cause is manually entered by an operator of the data processing system.

20. The computer program product of claim 16, wherein the method further comprises:
computing a composite excellency score for each corresponding one of the remaining ones of the transactions in the set by:
first computing for each of the remaining ones of the transactions a component excellency score for each supplier in the supply chain associated with a corresponding one of the remaining ones of the transactions in the set and
second compositing the component excellency scores into the composite excellency score; and,
combining each composited excellency scores for each of the remaining ones of the transactions into the supply chain excellency score.

21. The computer program product of claim 20, wherein when combining the composited excellency scores the composited excellency scores for more recent ones of the remaining ones of the transactions are weighted more heavily than composited excellency scores for less recent ones of the remaining ones of the transactions.
